(19) United States
(12) Patent Application Publication
(10) Pub. No.: US 2025/0014435 A1
(43) Pub. Date: Jan. 9, 2025

(54) Self-Righting Garage Bay Parking Aid Device

(71) Applicant: Wesley Pope, Barwick, GA (US)

(72) Inventor: Wesley Pope, Barwick, GA (US)

(21) Appl. No.: 18/735,499

(22) Filed: Jun. 6, 2024

Related U.S. Application Data
(60) Provisional application No. 63/511,752, filed on Jul. 3, 2023.

(51) Int. Cl. G08B 5/00

(52) U.S. Cl. CPC G08B 5/00

(57) ABSTRACT

A self-righting garage bay parking aid device is provided. The device provides a physical guide for vehicles entering a garage bay, ensuring accurate positioning of the vehicle within the bay. The device comprises a base with a top wall, bottom wall, front wall, and a rear wall, the latter formed by two angled sections to aid in returning the base to an upright position if knocked over. The top wall may include a receiving member that receives a vertical member (which may also be comprised of a marker) that is used as a visual guide by the user. The device may also have protective exterior layers to prevent vehicle damage upon inadvertent contact with the device while parking.

### CROSS-REFERENCE TO RELATED APPLICATION

The present application claims priority to, and the benefit of, U.S. Provisional Application No. 63/511,752, which was filed on Jul. 3, 2023, and is incorporated herein by reference in its entirety.

### FIELD OF THE INVENTION

The present invention relates generally to the field of vehicle positioning devices. More specifically, the present invention relates to a self-righting garage bay parking aid device that can be positioned within a garage bay and is comprised of visual extending members that facilitate specific vehicle positioning within the garage bay. Accordingly, the present disclosure makes specific reference thereto. Nonetheless, it is to be appreciated that aspects of the present invention are also equally applicable to other like applications, devices, and methods of manufacture.

### BACKGROUND

Individuals who park in a garage bay may experience difficulty accurately judging the position of their vehicle in relation to the garage door. This issue can lead to several potential problems. If a vehicle is parked too close to the door, there is a risk that the door will come down onto the car when it closes, causing damage that often requires costly repairs. Conversely, if a vehicle is parked too far from the garage door, insufficient space may be left to maneuver around the vehicle comfortably, complicating the process of exiting the garage. Additionally, improper parking can impede the functionality of other garage equipment or storage areas, further contributing to inconvenience and potential hazards. As a result, ensuring a vehicle is correctly positioned within a garage is essential for maintaining both the vehicle's condition and the garage's usability.

Therefore, there exists a long-felt need in the art for a garage parking aid. There also exists a long-felt need in the art for a self-righting garage bay parking aid device. More specifically, there exists a long-felt need in the art for a self-righting garage bay parking aid device that can be used to guide a user's vehicle to a proper position within a garage bay. In addition, there exists a long-felt need in the art for a self-righting garage bay parking aid device that can be used to guide a user's vehicle to a proper position within a garage bay, wherein the device can be easily placed within a garage bay and can be returned to an operable position if accidentally knocked over by a vehicle during parking in the garage bay.

The subject matter disclosed and claimed herein, in one embodiment thereof, comprises a self-righting garage bay parking aid device. The device fitted with a wood dowel provides a physical guide for vehicles entering a garage bay, ensuring accurate positioning of the vehicle within the bay. The device consists of a metal rectangular base with a top wall, bottom wall, front wall, and a rear wall, the latter having a 30 degree angle section extending rearward from the base to aid in returning the base to an upright position if knocked over, which is aided by a counter weight mounted on the front wall. The top wall may include a receiving member that receives a vertical member (which may also be comprised of a marker) that is used as a visual guide by the user. The device may also have protective exterior layers to prevent vehicle damage upon inadvertent contact with the device while parking. The top wall is fitted with a vertical sleeve/tubing that receives a user provided ½″ dowel, the tip of which can be painted, flagged or topped with a tennis ball to increase visibility.

In this manner, the self-righting garage bay parking aid device of the present invention accomplishes all the forgoing objectives and provides a garage parking aid. More specifically, the device can be used to guide a user's vehicle to a proper position within a garage bay. In addition, the angle formed by the rear walls ensures the device is returned to an operable, upright position if accidentally knocked over 30 degrees from vertical by a vehicle during parking in the garage bay.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-righting garage bay parking aid device that can be positioned within a garage bay to provide a user pulling into the garage bay a physical guide in order to ensure the vehicle is pulled into the garage bay at a specific position, depth, etc. The device is comprised of a base preferably comprised of a top wall and a generally parallel bottom wall. The base is also comprised of a front wall that is preferably generally perpendicular to the bottom wall and top wall. The base is also comprised of a first rear wall that is attached to a second rear wall that together preferably forms an angle equal to or less than 90 degrees. The angle of the walls allows the base to return to an upward position if knocked over by a vehicle. The upward return of the base may be aided via at least one counterweight positioned anywhere in the base.

The top wall may be comprised of at least one receiving member that allows at least one vertical member to be inserted into the receiving member. In one embodiment, the top wall has no member, wherein the vertical member is fixedly attached to the top wall. The member may also be comprised of at least one marker that may be any size, shape, and configuration such as but not limited to a sphere.

In one embodiment, the base unit is designed to set on the garage bay floor below the vehicle front bumper with the upright vertical member (wood dowel) engaging the vehicle bumper eliminating the possibility of damage to the vehicle.

The present invention is also comprised of a method of using the device. First, a device is provided comprised of a base comprised of a first rear wall that forms an angle with a second rear wall, at least one vertical member, and at least one marker. The user can position the device in a desired position within a garage bay such that the position of the member and marker corresponds to the distance the user has to pull a vehicle into the garage bay. Finally, a user can pull a vehicle into the garage bay up to the vertical member and marker, such that if the marker and/or member is accidentally impacted by the vehicle, the angle formed by the rear walls (and that may also be aided by a counterweight) will return the device into an upright position once the vehicle is rolled back.

Accordingly, the self-righting garage bay parking aid device of the present invention is particularly advantageous as it provides a garage parking aid. More specifically, the device can be used to guide a user's vehicle to a proper position within a garage bay. In addition, the angle formed by the rear walls ensures the device is returned to an operable, upright position if accidentally knocked rearward by a vehicle during parking in the garage bay. In this manner, the self-righting garage bay parking aid device provides a solution to precisely and accurately parking a vehicle within a garage bay. Moreover, the device can be easily relocated within the garage bay to accommodate vehicles of differing lengths, useful when changing vehicles. This can be easily done by placing a tack/nail in the hole provided in the vertical sleeve/tubing mounted on the base—simply pick up the base by the dowel and relocate.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enhanced perspective view of a base of one potential embodiment of a self-righting garage bay parking aid device of the present invention in accordance with the disclosed architecture;

FIG. 2 illustrates an enhanced perspective view of a base of one potential embodiment of a self-righting garage bay parking aid device of the present invention in accordance with the disclosed architecture; and

FIG. 3 illustrates a flowchart of a method of using one potential embodiment of a self-righting garage bay parking aid device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a garage parking aid. There also exists a long-felt need in the art for a self-righting garage bay parking aid device. More specifically, there exists a long-felt need in the art for a self-righting garage bay parking aid device that can be used to guide a user's vehicle to a proper position within a garage bay. In addition, there exists a long-felt need in the art for a self-righting garage bay parking aid device that can be used to guide a user's vehicle to a proper position within a garage bay, wherein the device can be easily placed within a garage bay and can be returned to an operable position if accidentally knocked over by a vehicle during parking in the garage bay.

The present invention, in one exemplary embodiment, is comprised of a self-righting garage bay parking aid device. The device can be positioned within a garage bay to provide a user pulling into the garage bay a physical guide in order to ensure the vehicle is pulled into the garage bay at a specific position, depth, etc. The device is comprised of a base preferably comprised of a top wall and a generally parallel bottom wall, and a front wall that is preferably generally perpendicular to the bottom wall and top wall. The base is also comprised of a first rear wall that is attached to a second rear wall that together preferably forms an angle equal to or less than 90 degrees such that the base returns to an upward position if knocked over by a vehicle. The upward return of the base may be aided via at least one counterweight positioned anywhere in the base.

The top wall may be comprised of at least one receiving member that allows at least one vertical member to be inserted into the receiving member. In one embodiment, the top wall has no member, wherein the vertical member is fixedly attached to the top wall. The member may also be comprised of at least one marker that may be any size, shape, and configuration such as but not limited to a sphere.

In one embodiment, the base, vertical member, and/or marker may be comprised of a protective exterior layer, such as but not limited to a felt or other fabric. This layer prevents the base, member, and/or marker from damaging a front end of a vehicle in the event that the vehicle contacts the same.

The present invention is also comprised of a method of using the device. First, a device is provided comprised of a base comprised of a first rear wall that forms an angle with a second rear wall, at least one vertical member, and at least one marker. Next, a user can position the device in a desired position within a garage bay such that the position of the member and marker corresponds to the distance the user has to pull a vehicle into the garage bay. Finally, a user can pull a vehicle into the garage bay up to the vertical member and marker, such that if the marker and/or member is accidentally impacted by the vehicle, the angle formed by the rear walls (and that may also be aided by a counterweight) will return the device into an upright position.

Accordingly, the self-righting garage bay parking aid device of the present invention is particularly advantageous as it provides a garage parking aid. More specifically, the device can be used to guide a user's vehicle to a proper position within a garage bay. In addition, the angle formed by the rear walls ensures the device is returned to an operable, upright position if accidentally knocked over by a vehicle during parking in the garage bay. In this manner, the self-righting garage bay parking aid device provides a solution to precisely and accurately parking a vehicle within a garage bay.

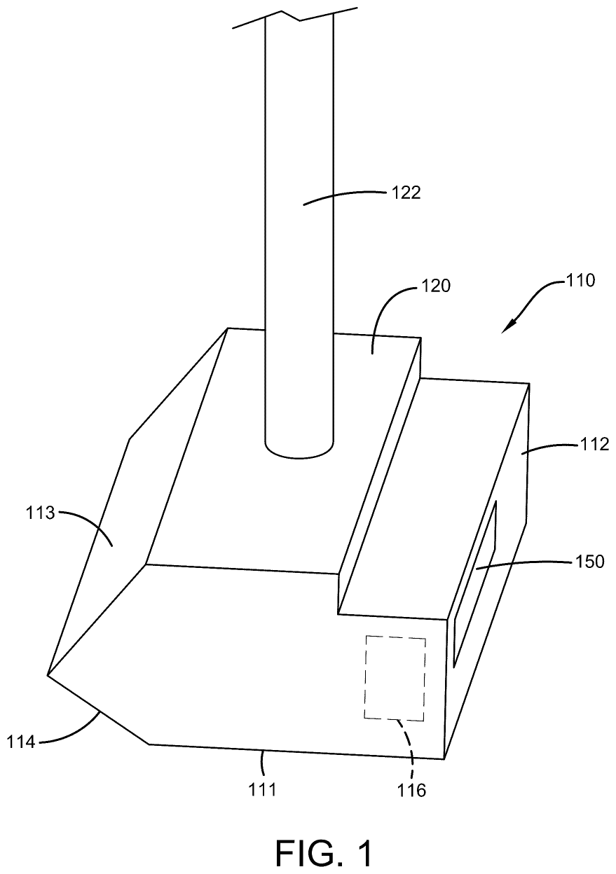

Referring initially to the drawings, FIG. 1 illustrates an enhanced perspective view of a base 110 of one potential embodiment of a self-righting garage bay parking aid device of the present invention in accordance with the disclosed architecture. The device 100 can be positioned within a garage bay to provide a user pulling into the garage bay a physical guide in order to ensure the vehicle is pulled into the garage bay at a specific position, depth, etc. The device 100 is comprised of a base 110. The base 110 is preferably comprised of a top wall 120 and a generally parallel bottom wall 111. The base 110 is also comprised of a front wall 112 that is preferably generally perpendicular to the bottom wall 111 and top wall 120. The base 110 is also comprised of a rear wall. The rear wall is comprised of a first rear wall 113 that is attached to a second rear wall 114. Together, the rear walls 113,114 form an angle equal to or less than 90 degrees. However, the walls 113,114 may form any angle between 1 and 179 degrees in different embodiments. The angle of the walls 113,114 allows the base 110 to return to an upward position if knocked over by a vehicle. The upward return of the base 110 may be aided via at least one counterweight 115 positioned anywhere in the base 110.

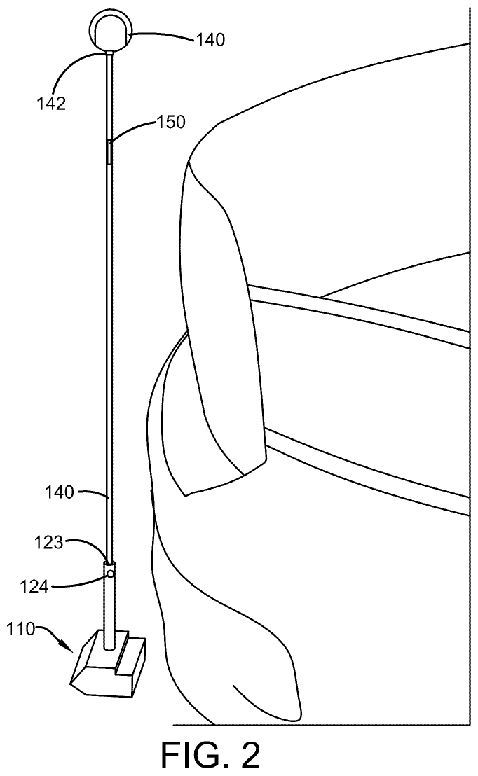

The top wall 120 may be comprised of at least one receiving member 122. The member 122 is preferably cylindrical with an opening 123. The opening 123 allows at least one vertical member 130 to be inserted into the receiving member 122, as seen in FIG. 2. In one embodiment, the top wall 120 has no member 122, wherein the vertical member 130 is fixedly attached to the top wall 120. In a different embodiment, the vertical member 130 can be removably secured into the receiving member 122 via at least one fastener 124 such as but not limited to a bolt or a set screw.

The vertical member 130 may be any color such that it is highly visible to a user pulling a vehicle into a garage bay. In one embodiment, the member 130 is comprised of a reflective material to improve visibility. The member 130 may also be comprised of at least one marker 140. The marker 140 may be any size, shape, and configuration such as but not limited to a sphere. The marker 140 may be made of the same or differing material as the member 130. In one embodiment, the marker 140 is fixedly attached to the member 130. In another embodiment, the marker 140 is removably attached to the member 130 via at least one fastener 142 such as but not limited to a magnet, a bolt, a set screw, a tongue, a groove, etc. In one embodiment, the base 110, vertical member 130, and/or marker 140 may be comprised of a protective exterior layer 150, such as but not limited to a felt or other fabric, that prevents the base 110, member 130, and/or marker 140 from damaging a front end of a vehicle in the event that the vehicle contacts the same.

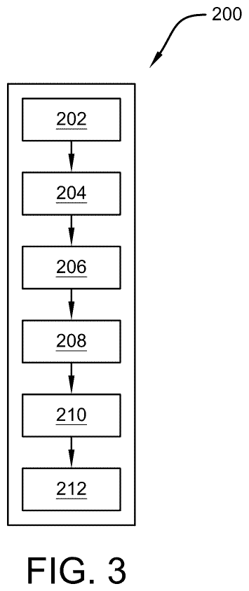

The present invention is also comprised of a method of using 200 the device 100, as seen in FIG. 3. First, a device 100 is provided comprised of a base 110 comprised of a first rear wall 113 that forms an angle with a second rear wall 114, at least one vertical member 130, and at least one marker 140 [Step 202]. Then, the vertical member 130 can be inserted into a receiving member 122 of the base 110 [Step 204]. In one embodiment, the member 130 can be secured within the receiving member 122 via at least one fastener 124 [Step 206]. Further, in an embodiment wherein the marker 140 is removably attached to the vertical member 130, the marker 140 can be attached to the member 130 via at least one fastener 142 [Step 208]. Next, a user can position the device 100 in a desired position within a garage bay such that the position of the member 130 and marker 140 corresponds to the distance the user has to pull a vehicle into the garage bay [Step 210]. Finally, a user can pull a vehicle into the garage bay up to the vertical member 130 and marker 140, such that if the marker 140 and/or member 130 is accidentally impacted by the vehicle, the angle formed by the rear walls 113,114 (and that may also be aided by a counterweight 116) will return the device 100 into an upright position [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-righting garage bay parking aid device” and “device” are interchangeable and refer to the self-righting garage bay parking aid device 100 of the present invention.

Notwithstanding the forgoing, the self-righting garage bay parking aid device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the self-righting garage bay parking aid device 100 as shown in the FIGS. are for illustrative purposes only, and that many other sizes and shapes of the self-righting garage bay parking aid device 100 are well within the scope of the present disclosure. Although the dimensions of the self-righting garage bay parking aid device 100 are important design parameters for user convenience, the self-righting garage bay parking aid device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-righting garage bay parking aid device comprising:
a base comprised of a first rear wall that forms an angle with a second rear wall, and a counterweight;
a vertical member that extends from a top surface of the base; and
a marker attached to the vertical member.

2. The self-righting garage bay parking aid device of claim 1, wherein the base is comprised of a protective exterior layer comprised of a fabric.

3. The self-righting garage bay parking aid device of claim 1, wherein the vertical member is comprised of a protective exterior layer comprised of a fabric.

4. The self-righting garage bay parking aid device of claim 1, wherein the marker is comprised of a protective exterior layer comprised of a fabric.

5. The self-righting garage bay parking aid device of claim 1, wherein the vertical member is comprised of a reflective material.

6. The self-righting garage bay parking aid device of claim 1, wherein the marker is comprised of a reflective material.

7. The self-righting garage bay parking aid device of claim 1, wherein the angle formed by the first rear wall and the second rear wall is equal to or less than 90 degrees.

8. A self-righting garage bay parking aid device comprising:
a base comprised of receiving member that extends from a top surface of a base, and a first rear wall that forms an angle with a second rear wall, and a counterweight;
a vertical member; and
a marker attached to the vertical member.

9. The self-righting garage bay parking aid device of claim 8, wherein the base is comprised of a protective exterior layer comprised of a fabric.

10. The self-righting garage bay parking aid device of claim 8, wherein the vertical member is comprised of a protective exterior layer comprised of a fabric.

11. The self-righting garage bay parking aid device of claim 8, wherein the marker is comprised of a protective exterior layer comprised of a fabric.

12. The self-righting garage bay parking aid device of claim 8, wherein the vertical member is comprised of a reflective material.

13. The self-righting garage bay parking aid device of claim 8, wherein the marker is comprised of a reflective material.

14. The self-righting garage bay parking aid device of claim 8, wherein the angle formed by the first rear wall and the second rear wall is between 1 and 179 degrees.

15. The self-righting garage bay parking aid device of claim 8, wherein the receiving member is comprised of an opening that receives the vertical member.

16. The self-righting garage bay parking aid device of claim 15, wherein the vertical member is secured within the receiving member via a first fastener.

17. The self-righting garage bay parking aid device of claim 15, wherein the marker is attached to the vertical member via a second fastener.

18. A method of using a self-righting garage bay parking aid device, the method comprising the following steps:
providing a self-righting garage bay parking aid device comprised of a base comprised of a first rear wall that forms an angle with a second rear wall, a vertical member, and a marker;
positioning the self-righting garage bay parking aid device within a garage bay such that a position of the vertical member or a position of the market corresponds to a distance that a user has to pull a vehicle into the garage bay; and
pulling the vehicle into the garage bay up to the vertical member and the marker.

19. The method of using a self-righting garage bay parking aid device of claim 18, wherein the marker is attached to the vertical member.

20. The method of using a self-righting garage bay parking aid device of claim 18, wherein the vertical member is attached to the base.
